(19) United States
(12) Patent Application Publication
(10) Pub. No.: US 2020/0208623 A1
(43) Pub. Date: Jul. 2, 2020

(54) Pneumatic Motor Comprising Active Stroke-Switching System

(71) Applicant: Henkel AG & Co. KGaA, Duesseldorf (DE)

(72) Inventor: Christoph Schmid, Maisach OT. Gernlinden (DE)

(21) Appl. No.: 16/732,773

(22) Filed: Jan. 2, 2020

Related U.S. Application Data
(63) Continuation of application No. PCT/EP2018/067974, filed on Jul. 3, 2018.

(30) Foreign Application Priority Data
Jul. 3, 2017 (DE) 10 2017 211 269.7

(51) Int. Cl. F04B 39/10; F16K 31/122; F16K 1/12; F04B 41/02; F04B 39/00

(52) U.S. Cl. CPC F04B 39/10; F16K 31/1221; F16K 1/126; F05B 2270/502; F04B 39/0022; F04B 2205/03; F05B 2270/325; F04B 41/02

(57) ABSTRACT

The invention relates to a pneumatic motor (1) for a feed pump, comprising —a motor cylinder (10) and a motor piston (11) which is moveably arranged in the motor cylinder (10) and to which compressed air is applied, —a valve unit (30), the compressed air providing for a downward movement (17) of the motor piston (11) when the valve unit (30) is in a first valve position and for an upward movement (19) of the motor piston (11) in the motor cylinder (10) when the valve unit is in a second valve position, —upper stop means for the valve unit (30), by means of which the valve unit (30) is switched from the second valve position to the first valve position and thus the upward movement (19) is changed to the downward movement (17), and —lower stop means for the valve unit (30), by means of which the valve unit (30) is switched from the first valve position to the second valve position and thus the downward movement (17) is changed to the upward movement (19). According to the invention, an active stroke-switching system (50) is provided, which comprises a switching cylinder (51) and a switching piston (52) which can move in the switching cylinder (51) and is coupled to the valve unit (30). The invention further relates to a method for operating the pneumatic motor.

The invention relates to a pneumatic motor for a feed pump. The invention further relates to a method for operating the pneumatic motor.

Feed pumps driven by a pneumatic motor are used in many sectors for pumping liquids. The pneumatic motor has, in these cases, a motor cylinder and a motor piston, which is arranged in the motor cylinder such that it can move up and down, and to which compressed air is applied. A delivery pressure of the feed pump is proportional to the pressure of the compressed air.

By means of a valve unit arranged on the motor piston in combination with upper and lower stop means for the valve unit, the stroke direction of the motor piston is automatically reversed in the pneumatic motor. When the valve unit is in a first valve position, the compressed air provides for a downward movement of the motor piston. Conversely, when the valve unit is in a second valve position, the motor piston moves in the opposite direction, i.e. the compressed air provides for an upward movement of the motor piston. When the valve unit strikes the upper stop means in the upward movement, which means being in the form of a fixed upper end stop, the valve unit is switched from the second valve position to the first valve position, as a result of which the upward movement is changed to the downward movement. Upon reaching the lower stop means, which means being in the form of a fixed lower end stop, the valve unit is switched from the first valve position to the second valve position. Accordingly, this also results in the stroke direction of the motor piston being reversed.

In order to ensure that the valve unit is reliably switched, it is known from the prior art to couple the valve unit to a rocker mechanism having a spring. This spring is tensioned when the valve unit or the coupling between the rocker mechanism and the valve unit hits one of the two end stops so that said spring is ultimately relaxed in an abrupt manner. The energy released in the process is used to reliably switch the valve unit. The tensioning of the spring requires, however, a certain level of pressure for the compressed air acting on the motor piston, and therefore the motor piston does not come to a standstill immediately before its end positions. Furthermore, there is a drop in the delivery pressure before the end positions of the motor piston, since a significant portion of the energy provided by the compressed air is required for tensioning the spring.

Therefore, due to the proportionality between the delivery pressure and the pressure of the compressed air that acts on the motor piston, the pneumatic motor cannot be readily used in applications in which it is desirable for the feed pump to have a low delivery pressure. An additional pressure regulator for the liquid, which is connected downstream of the feed pump, can reduce the delivery pressure to the desired level. Furthermore, the pressure regulator can respond to the drop in the delivery pressure caused by the spring being tensioned. Nevertheless, the additional pressure regulator for the liquid results in significant additional costs and increased complexity.

Therefore, the problem addressed by the invention is to provide a pneumatic motor for a feed pump that has a simple design and allows the feed pump to have a low delivery pressure.

The problem addressed by the invention is solved by the combination of features according to claim 1. Embodiments of the invention can be found in the claims dependent on claim 1.

According to the invention, the pneumatic motor is provided with an active stroke-switching system, which comprises a switching cylinder and a switching piston that is movably arranged in the switching cylinder and is coupled to the valve unit. The switching piston assumes the function of the end stops from the pneumatic motor known from the prior art, but with the difference that the switching piston is not fixed, but rather actively moved so as to reverse the stroke direction of the motor piston. As a result, the time required for switching the valve unit can be reduced such that, even at low delivery pressures of the delivery pump, the motor piston is not at a standstill (for a prolonged time period) when the stroke direction is being reversed, which prolonged standstill would have a negative effect on the stability of the delivery pressure. Although the static forces which are necessary for switching the valve unit and which correspondingly act on the motor piston are not reduced by the active stroke-switching system, the time required for switching the valve unit is significantly reduced by comparison with the passive stroke-switching system comprising fixed end stops. It has been found that the valve unit being switched actively and thus more quickly has no influence, or only a very small influence, on the course of the delivery pressure of the feed pump. In addition, the time for switching the valve unit and the piston speed of the motor piston are disassociated by means of the active stroke-switching system. Therefore, the delivery pressures can be significantly reduced by means of the active stroke-switching system, since no additional delivery pressure is required for the stroke switching. Delivery pressures of less than 10 bar can therefore be achieved. The pressure of the compressed air may assume values of below 2 bar (preferably 0.5 to 1.5 bar), for example. By comparison with a “conventional” pneumatic motor which comprises fixed end stops and is operated at a pressure for the compressed air of approximately 3 bar and above, this entails a reduction in the pressure of the compressed air and thus in the delivery pressure of the feed pump by a factor of greater than 2 or approximately 6.

In other words, the switching piston and its targeted pressurization at least partially form the upper and lower stop means, by means of which the valve unit is switched.

A movement axis of the switching piston can coincide with a movement axis of the motor piston. As a result, the valve unit to be switched and the switching piston can be coupled to one another in a simple manner, if the valve unit is arranged on the motor piston and moves therewith within the motor cylinder. In this case, the first valve position and the second valve position of the valve unit relate to positions of the valve unit relative to the motor piston. A switching path of the valve unit (path between the valve positions) preferably extends in parallel with the movement axes of the switching piston and the motor piston.

In one embodiment, the active stroke-switching system comprises a switching valve which provides for a downward movement of the switching piston in a first switching position and for an upward movement of the switching piston in a second switching position. In this case, in the first switching position, a first or upper cylinder chamber of the motor cylinder can be pressurized, while at the same time a second or lower cylinder chamber of the motor cylinder remains pressurized. The pressurization occurs through the motor piston from the lower cylinder chamber. When the switching valve is in the second switching position, the second cylinder chamber of the motor cylinder remains pressurized and the first cylinder chamber of the motor cylinder is depressurized. Regardless of the orientation and position of the motor piston, the downward movement of the switching piston should be the movement of the switching piston in which the first cylinder chamber of the switching cylinder gets larger and the second cylinder chamber gets smaller.

The switching valve can depressurize the switching piston in a third switching position. In the corresponding embodiment, this means that both the first cylinder chamber and the second cylinder chamber of the switching cylinder are depressurized. The third switching position is preferably a spring-loaded rest position of the switching valve, i.e. a position assumed by the switching valve automatically.

In one embodiment of the invention, the switching piston is connected to a rocker mechanism which comprises an energy storage means and acts on the valve unit. The energy storage means can be designed as the above-described spring, which absorbs and stores energy by being tensioned and is able to release said energy again relatively quickly. The connection of the switching piston to the rocker mechanism or at least to part of the rocker mechanism may be rigid, for example achieved by a switching piston rod extending between the switching piston and the rocker mechanism.

The upper stop means can comprise a fixed upper end stop on the switching cylinder. This upper end stop can be designed, for example, as the upper end wall of the switching cylinder, which defines the first or upper cylinder chamber. Accordingly, the lower stop means can also comprise a fixed lower end stop. Therefore, even if the first cylinder chamber is not pressurized, which, in normal operation of the pneumatic motor according to the invention, results in the stroke direction being switched from the upward movement to the downward movement of the switching piston, the pneumatic motor can in principle continue to be operated in an emergency operation mode (for example if actuation of the control valve fails). The switching piston hits the upper end wall of the switching cylinder, as a result of which the valve unit is switched in a manner analogous to that in the conventional pneumatic motor. In the emergency operation mode, however, the conditions relating to delivery pressure and delivery rate, as in a conventional pneumatic motor without an active stroke-switching system, should once again be observed. However, this embodiment requires only minor changes to the conventional pneumatic motor, with the advantage that, in the operating mode of the pneumatic motor according to the invention, the conventional operating mode involving the fixed end stops can be readily reverted to.

The active stroke-switching system can comprise a controller and a first proximity switch arranged on the switching cylinder, the controller being designed to switch the switching valve to the first switching position when the switching piston reaches the first proximity switch in the upward movement. The first proximity switch can be connected to the controller via a signal line. In the first switching position, the upper cylinder chamber is pressurized, and therefore the switching piston performs a downward movement in the switching cylinder, which counteracts the upward movement of the motor piston that is still being performed. The valve unit is switched by the downward movement of the switching piston to the first valve position, as a result of which the upward movement of the motor piston is stopped and the downward movement of the motor piston is started.

The stroke-switching system can comprise a second proximity switch, the controller being designed to switch the switching valve to the second switching position when the switching piston reaches the second proximity switch in the downward movement. A further signal line is preferably provided between the second proximity switch and the controller. Due to the second switching position of the switching valve, the second or lower cylinder chamber remains pressurized and the first or upper cylinder chamber is depressurized, and therefore the valve unit is actively switched by a movement of the switching piston in this case too.

The controller can be designed to temporarily hold the switching valve in the first switching position or in the second switching position. When one of the proximity switches is reached, the switching valve can apply pressure to the first or second cylinder chamber of the switching cylinder for a time period of, for example, 0.5 to 1 sec. This duration is sufficient to switch the valve unit or to tension the spring of the rocker mechanism to such an extent that said spring is ultimately relaxed in an abrupt manner and thereby switches the valve unit. The switching piston can be depressurized between the proximity switches such that it moves synchronously with the motor piston. Only when the valve unit is switched does a relative movement occur between the switching piston and the motor piston.

Another problem addressed by the invention, namely that of providing a method for operating the above-described pneumatic motor according to the invention, is solved by claim 10. According to claim 10, the force generated by the switching piston is greater than the force required for switching the valve unit. As a result, the speed of the motor piston and the speed of the switching piston are disassociated when switching the valve unit, as a result of which the valve unit can be switched more quickly.

When the switching pressure is applied to the switching piston, the time period can be divided into a first phase, in which the switching pressure acts on the motor piston indirectly via the switching piston and the motor pressure acts on the motor piston in the opposite direction, and a second phase, in which the switching pressure acts on the motor piston via the switching piston and the motor pressure acts on the motor piston in the same direction. The first phase can amount to 60 to 80% of the time period, whereas the second phase correspondingly lasts for 40 to 20% of the total time period. In the second phase, an additional energy can be supplied to the motor piston via the switching piston, which energy corresponds to the energy lost during the tensioning and relaxing of the spring of the rocker mechanism (compensation for the hysteresis losses of the spring).

### BRIEF DESCRIPTION OF THE DRAWINGS

The invention is described in more detail with reference to an embodiment shown in the drawings, in which:

FIG. 1 is a sectional view of a pneumatic motor according to the invention, comprising a motor piston and a valve unit;

FIG. 2 is a sectional view of the pneumatic motor with the valve unit in a changed valve position and the motor piston in a different piston position;

FIG. 3 is a sectional view of the pneumatic motor with the motor piston in a top dead center;

FIG. 4 is a sectional view of the pneumatic motor after passing through the top dead center;

FIG. 5 is a perspective view of the pneumatic motor;

FIG. 6 shows the pneumatic motor according to FIG. 5 with the valve unit in a changed valve position;

FIG. 7 is a sectional view of the pneumatic motor according to FIG. 6; and

FIG. 8 is a pneumatic circuit diagram for the pneumatic motor according to the invention.

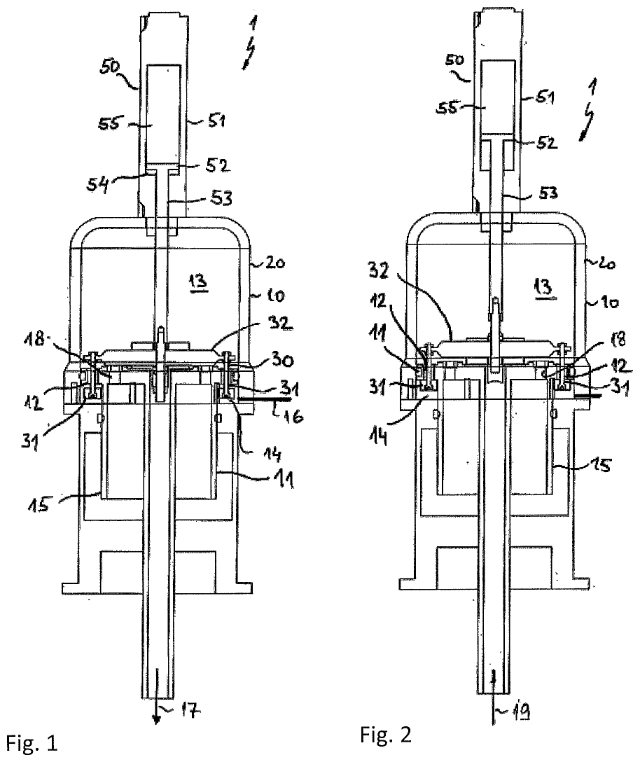

FIGS. 1 to 4 show a pneumatic motor, which is denoted as a whole by reference sign 1. The pneumatic motor 1 comprises a motor cylinder 10, in which a motor piston 11 is arranged such that it can move up and down. A valve unit 30 is movably fastened to the motor piston 11. In the views from FIGS. 1 to 4, a switching cylinder 51 is arranged at the upper end of the motor cylinder 10, in which switching cylinder a switching piston 52 is located. The switching piston 52 is coupled to the valve unit 30 by means of a switching piston rod 53. The switching cylinder 51 and the switching piston 52 are parts of an active stroke-switching system, which is discussed in more detail below. The stroke-switching system is denoted by reference sign 50.

By means of the pneumatic motor 1, it is possible, for example, to drive a feed pump which pumps a viscous liquid, such as a liquid adhesive, at a comparatively low delivery rate (<500 ml/min). The delivery pressure of the feed pump is preferably below 30 bar. The feed pump is not discussed in any more detail below.

FIGS. 1 to 4 show the motor piston 10, the valve unit 30 and the switching piston 52 in various positions. In FIG. 1, the valve unit 30 is in a first valve position. The valve unit 30 comprises two valves 31, which are interconnected by a valve bar 32. In FIG. 2, the valve unit 30 is in a second valve position. In this position, the valves 31 close through-openings 12 in the motor piston 11, the through-openings 12 extending from an upper motor cylinder chamber 13 to a lower motor cylinder chamber 14. That is to say, in the second valve position, the valve unit 30 separates the upper motor cylinder chamber 13 from the lower motor cylinder chamber 14. Due to a motor piston shaft 15, the lower motor cylinder chamber 14 has an annular cross section, whereas the upper motor cylinder chamber 13 has a circular cross section. Since the cross-sectional area of the motor piston 11 on the side of the upper motor cylinder chamber 13 is larger than the cross-sectional area of the motor piston 11 on the side of the lower motor cylinder chamber 14, a pressure of compressed air, introduced into the lower motor cylinder chamber 14 via a compressed air line denoted by reference sign 16, brings about, in principle, a downward movement 17 (see FIG. 4) when the valve unit 30 is in the first valve position. In the second valve position, the upper motor cylinder chamber 13 is decoupled from the compressed air from the compressed air line 16, it being possible to vent the upper motor cylinder chamber 13 by vent openings 18 in the motor piston 11. As can be seen, for example, from FIG. 2, the valve bar 32 exposes these vent openings 18 in the second valve position. Therefore, when the valve unit 30 is in the second valve position, only the lower motor cylinder chamber 15 is pressurized, whereas the upper motor cylinder chamber 13 is vented. Consequently, in the second valve position, the motor piston 11 will perform an upward movement 19. If the (effective) cross-sectional area of the motor piston on the side of the upper motor cylinder chamber is twice the cross-sectional area of the motor piston 11 on the side of the lower motor cylinder chamber 14, the resulting force on the motor piston 11 is equal in the downward movement 17 and the upward movement 19.

FIG. 1 shows the motor piston 11 in close proximity to a bottom dead center. If a lower cylinder chamber 54 of the switching cylinder 51 is then pressurized, the switching piston 52 moves together with the switching piston rod 53 upward and pushes the valve unit 30 from the first valve position shown in FIG. 1 into the second valve position shown in FIG. 2. As a result, the upper motor cylinder chamber 13 is depressurized and vented, and therefore the downward movement 17 is changed to an upward movement 19. FIG. 2 thus shows the states in the pneumatic motor 1 with a certain temporal offset from the states from FIG. 1.

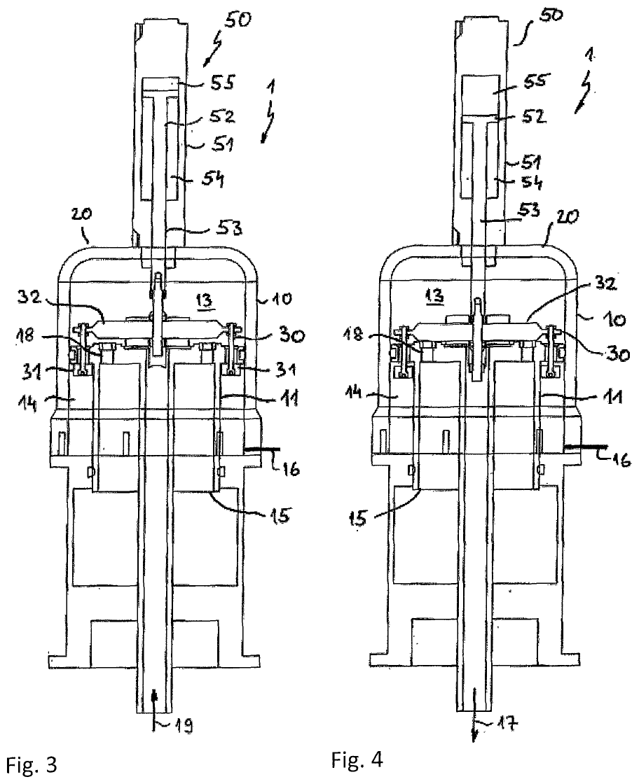

Proceeding from FIG. 2 with the upward movement 19 of the motor piston 11 taking place therein, the motor piston 11 reaches its top dead center, or gets close thereto, after a certain amount of time (see FIG. 3). By pressurizing an upper cylinder chamber 55 of the switching cylinder 51, the valve unit 30 can be pushed back into the first valve position from the second valve position shown in FIG. 3. Accordingly, the piston moves downward again (see downward movement 17 in FIG. 4).

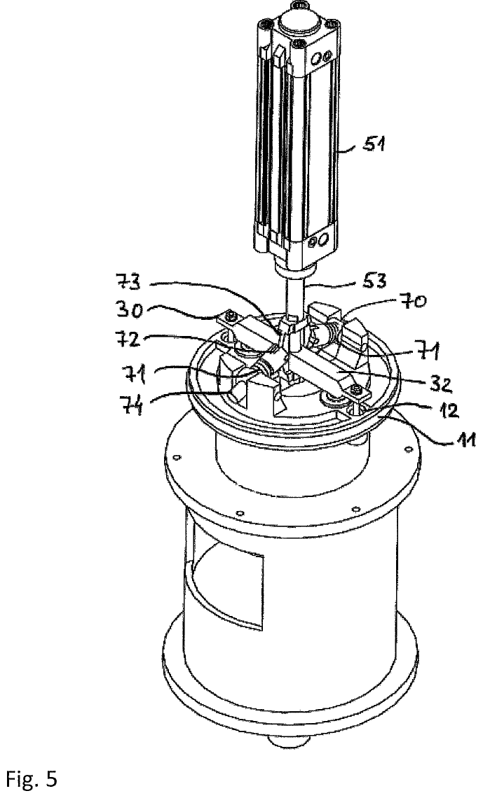

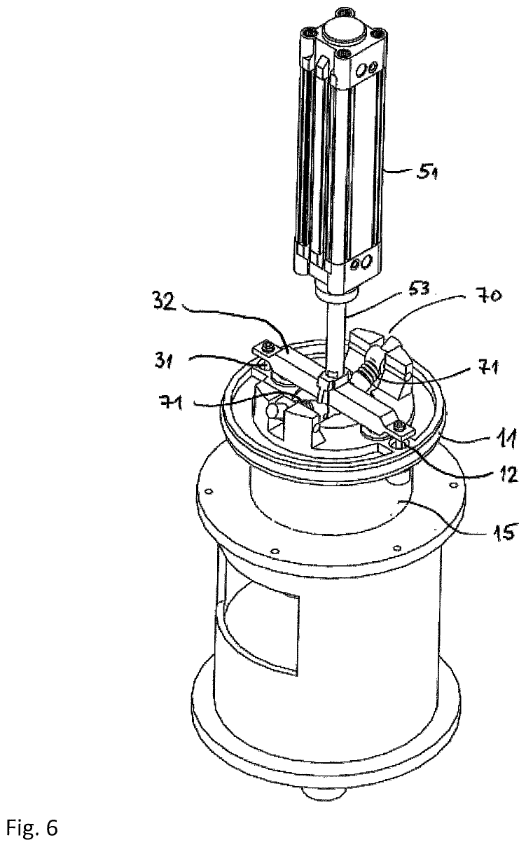

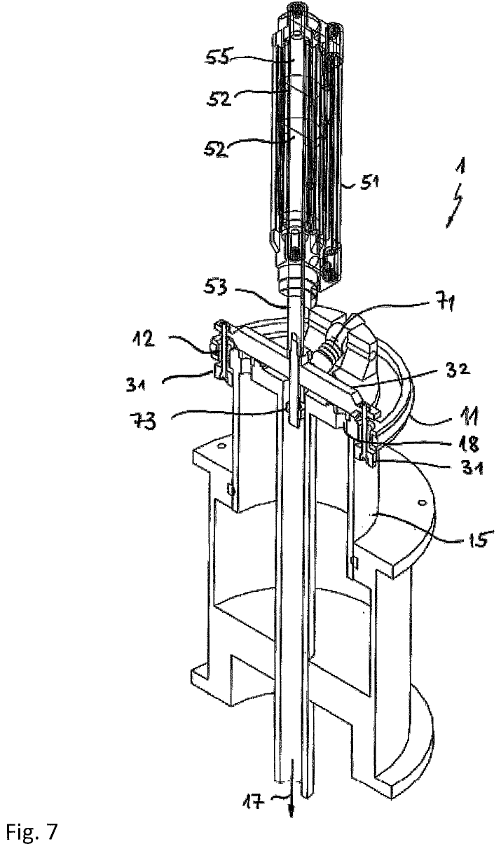

FIG. 5 is a perspective view of the pneumatic motor 1. For the sake of clarity, a cylinder head (denoted by reference sign 20 in FIGS. 1 to 4) is not shown in FIG. 5. In particular, FIG. 5 shows the structure of a rocker mechanism 70, which is connected to the switching piston rod 53 and acts on the valve unit 30. The valve position of the valve unit 30 shown in FIG. 5 corresponds to the second valve position (FIGS. 2 and 3). In FIG. 6, which shows the pneumatic motor 1 in the same view as FIG. 5, the valve unit 30 is in the first valve position (compare FIGS. 1 and 4). FIG. 7 is a longitudinal section through the pneumatic motor 1 from FIG. 6.

As can be seen in FIGS. 5 to 7, the rocker mechanism 70 comprises two springs 71 in the form of helical springs, which are rigidly connected by an inner end 72 to the switching piston rod 53 by means of a clamp 73. An outer end 74 of the helical spring 71 is pivotally mounted like the inner end 72. If, proceeding from the second valve position shown in FIG. 5, a downward force from the switching cylinder 51 then acts on the two clamps 53 via the switching piston rod 53, the helical springs 71 are compressed and pivoted slightly downward. In this case, the helical springs 71 are compressed to a point at which the longitudinal axes of the helical springs 71 are in a plane perpendicular to the switching piston rod 53. When the switching piston rod 53 moves further downward, the spring force of the tensioned helical springs 71 no longer acts counter to the force of the switching piston rod 53, but instead acts basically in the same direction, and therefore the tensioned helical springs 71 are relaxed in an abrupt manner and press the clamps 73 downward in a correspondingly rapid manner into a position, as shown in FIGS. 6 and 7. In the process, the clamp 73 presses against the valve bar 32 from above and thus knocks the valve unit 30 into the first valve position (see FIGS. 6 and 7).

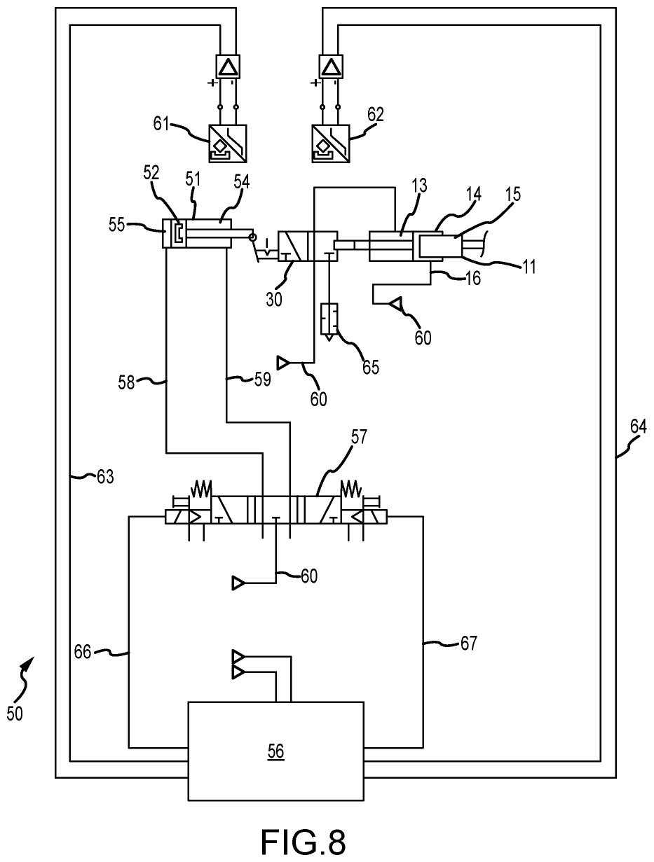

FIG. 8 is a pneumatic circuit diagram for the pneumatic motor 1 according to the invention or for the active switching system 50. The active stroke-switching system 50 comprises a controller 56 and a switching valve 57, which is designed as a 5/3-way valve. It can be seen that the switching valve 57 is connected to the upper cylinder chamber 55 of the switching cylinder 51 via a compressed air line 58. A further compressed air line 59 connects the switching valve 57 to the lower cylinder chamber 54 of the switching piston 51.

When the switching valve 57 is in the switching position shown in FIG. 8, the upper cylinder chamber 55 and the lower cylinder chamber 54 of the switching cylinder 51 are depressurized. The switching position of the switching valve 57 shown in FIG. 8 is intended to correspond to a third switching position of the switching valve.

When the switching valve 57 is in a first switching position, in which it would be switched to the right in the view of FIG. 8, the switching valve 57 connects a compressed air source 60 to the upper cylinder chamber 55 via the compressed air line 58. The switching piston 52 is thereby moved to the right or downward in the view of FIG. 8 such that the valve unit 30 (shown here schematically as a 2/2-way valve) is pushed into the first valve position, in which the upper motor piston chamber 13 is also connected to the compressed air source 60 (this corresponds to there being open through-openings 12 at the same time as closed vent openings 18). Due to the larger cross-sectional area of the motor piston 15 toward the side of the upper motor piston chamber 13, the motor piston 11 moves to the right in the view of FIG. 8, and so there is a downward movement of the motor piston 15.

In a second valve position, in which the switching valve 57 would theoretically be switched to the left in FIG. 8, the compressed air source 60 is connected to the lower cylinder chamber 54 of the switching cylinder 51 via the compressed air line 59. In this case, the valve unit 30 is in the second valve position (not shown in FIG. 8), in which the upper motor piston chamber 13 is vented via a muffler 65.

The active stroke-switching system 50 further comprises a first proximity switch 61 and a second proximity switch 62, which are connected to the controller 56 via signal lines 63 and 64, respectively. The proximity switches 61, 62 are fastened to the switching cylinder 51. The first proximity switch 61 may also be referred to as the upper proximity switch, since it is arranged on the switching cylinder 51 so as to be above the second or lower proximity switch 62.

If the motor piston 11 is in the upward movement 19, the switching piston 52 approaches the first proximity switch via the switching piston rod 53. In this case, the valve unit 30 is in the second valve position, in which the upper motor piston chamber 13 is vented. If the switching piston 52 then reaches the first proximity switch 61, said switch sends a signal to the controller 56 via the signal line 63, which controller then switches the switching valve 57 from the third position shown in FIG. 8 to the first switching position via a control line 66, as a result of which the upper cylinder chamber 55 is pressurized. The switching piston 52 thereby moves in the opposite direction to the motor piston 151 which is still in the upward movement 19 and ultimately pushes the valve unit 30 from the second valve position (see FIG. 3 or the switching position of the valve unit 30 in FIG. 8) into the first valve position by means of the rocker mechanism 70, in which first position the upper motor piston chamber 13 is also pressurized. Proceeding from the upward movement 19, this leads to the downward movement 17 of the motor piston 11 and thus to the stroke direction being reversed. In this case, the upper cylinder chamber 55 was pressurized only for a limited period of time (for example for 0.5 to 1 second). Thereafter, the switching valve 57 is switched to the third switching position, in which the switching piston 52 is depressurized. Upon the second or lower proximity switch 62 being reached, the controller 56 is made active by means of the signal line 64 and switches the switching valve 57 to the second switching position (to the left in FIG. 8) by means of a control line 67. This results in an upward movement of the switching piston, by means of which the valve unit 30 is switched from the first valve position to the second valve position by means of the rocker mechanism 70. Here, too, the switching valve 57 is switched back to the third switching position (rest position) after a short period of time, in which position the switching piston 52 and the motor piston 11 move synchronously in the same direction.

If the controller 56 fails, the control valve 57 remains in the position shown in FIG. 8. Accordingly, upon the proximity switch 61, 62 being reached, the cylinder chambers 54, 55 are not pressurized. Instead, the switching piston 52 moves into the dead center positions, determined by the dimensions of the switching cylinder. Upon such a mechanical dead center position being reached, there is a relative movement between the switching piston that is now seized and the motor piston that is still moving. In this case, the rocker mechanism is tensioned, which mechanism then initiates the switching of the valve unit 30, and this ultimately leads to the stroke direction being reversed. If the controller 56 fails, when the valve unit is switched, there is thus no active counter movement of the switching piston as in normal operation of the pneumatic motor 1 according to the invention, but rather only a relative movement between the switching piston and the motor piston, which is solely caused by the movement of the motor piston.

### LIST OF REFERENCE SIGNS

1 pneumatic motor
10 motor cylinder
11 motor piston
12 through-opening
13 upper motor cylinder chamber
14 lower motor cylinder chamber
15 motor piston shaft
16 compressed air line
17 downward movement
18 vent opening
19 upward movement
20 cylinder head
30 valve unit
31 valve
32 valve bar
50 stroke-switching system
51 switching cylinder
52 switching piston
53 switching piston rod
54 lower cylinder chamber
55 upper cylinder chamber
56 controller
57 switching valve
58 compressed air line
59 compressed air line
60 compressed air source
61 first proximity switch
62 second proximity switch
63 signal line
64 signal line
65 muffler
66 control line
67 control line
70 rocker mechanism
71 spring/helical spring
72 inner end
73 clamp
74 outer end

1. A pneumatic motor for a feed pump, comprising
a motor cylinder;
a motor piston which is movably arranged in the motor cylinder and to which compressed air can be applied;
a valve unit fluidly connected to a source of compressed air, the compressed air providing for a downward movement of the motor piston when the valve unit is in a first valve position and providing for an upward movement of the motor piston in the motor cylinder in a second valve position;
an upper stop for the valve unit, by which the valve unit is switched from the second valve position to the first valve position and the upward movement of the motor piston is changed to the downward movement;
a lower stop for the valve unit, by which the valve unit is switched from the first valve position to the second valve position, and the downward movement of the motor piston is changed to the upward movement; and
an active stroke-switching system, comprising a switching cylinder and a switching piston that is movably arranged in the switching cylinder and is coupled to the valve unit.

2. The pneumatic motor according to claim 1, wherein a movement axis of the switching piston coincides with a movement axis of the motor piston.

3. The pneumatic motor according to claim 1, wherein the active stroke-switching system comprises a switching valve which provides for a downward movement of the switching piston in a first switching position and for an upward movement of the switching piston in a second switching position.

4. The pneumatic motor according to claim 3, wherein the switching valve has a third switching position and depressurizes the switching piston in a third switching position.

5. The pneumatic motor according to claim 1, comprising a rocker mechanism including an energy storage means, the rocker mechanism being connected to the switching piston to act on the valve unit.

6. The pneumatic motor according to claim 1, wherein the upper stop comprises a fixed upper end stop on the switching cylinder and the lower stop comprises a fixed lower end stop on the switching cylinder.

7. The pneumatic motor according to claim 1, wherein the active stroke-switching system comprises a switching valve which provides for a downward movement of the switching piston in a first switching position and for an upward movement of the switching piston in a second switching position, the active stroke-switching system comprising a controller and a first proximity switch arranged on the switching cylinder, the controller switching the switching valve to the first switching position when the switching piston reaches the first proximity switch in the upward movement.

8. The pneumatic motor according to claim 7, wherein the active stroke-switching system further comprises a second proximity switch, the controller switching the switching valve to the second switching position when the switching piston reaches the second proximity switch in the downward movement.

9. The pneumatic motor according to claim 8, wherein the controller is designed to temporarily hold the switching valve in the first switching position or in the second switching position.

10. A method for operating a pneumatic motor according to claim 1, wherein the force applied by means of the switching piston is greater than the force required for switching the valve unit.
